(19) United States
(12) Patent Application Publication
(10) Pub. No.: US 2019/0356904 A1
(43) Pub. Date: Nov. 21, 2019

(54) METHODS AND SYSTEMS FOR STEREOSCOPIC PRESENTATION OF DIGITAL CONTENT

(71) Applicant: DOUBLE X VR LTD., Petach Tikva (IL)

(72) Inventor: Gal ROTEM, Petach Tikva (IL)

(21) Appl. No.: 16/474,077

(22) PCT Filed: Dec. 31, 2017
(86) PCT No.: PCT/IL2017/051406

§ 371 Date: Jun. 27, 2019

(30) Foreign Application Priority Data
Jan. 5, 2017 (GB) 1700121.5

(51) Int. Cl. H04N 13/261; H04N 13/218

(52) U.S. Cl. CPC H04N 13/261; H04N 13/225; H04N 13/218

(57) ABSTRACT

Computerized methods and systems create stereoscopic presentations of digital content. A depth transformation module receives an assigned depth value for each of one or more components in a layout editor. Each of the one or more components has an associated initial spatial position in two dimensions. The depth transformation module determines a corresponding offset value from the assigned depth value for each of the one or more components. For each of the one or more components, the initial spatial position of the component is shifted by the corresponding offset value separately in a first direction and a second direction. A rendering module presents the one or more components shifted in the respective first and second directions.

### CROSS-REFERENCE TO RELATED APPLICATIONS

This application claims priority from UK Provisional Patent Application No. 1700121.5, filed Jan. 5, 2017, whose disclosure is incorporated by reference in its entirety herein.

### TECHNICAL FIELD

The present invention relates to methods and systems for presenting digital content.

### BACKGROUND OF THE INVENTION

Platforms for building presentations of digital content are known in the art. For example, website building platforms can provide users with capability to build and develop websites without requiring knowledge of web development coding and scripting languages. Such platforms may utilize drag-and-drop functionality to allow users to select pre-existing components from a library and place those selected components in a layout editor for customization and personalization. However, such platforms operate with two-dimensional components that do not provide an indication of depth between such components. Typically, in order to provide depth, a three-dimensional presentation may be created, using three-dimensional imaging techniques, such as capturing images of the same pixel at multiple views, using a three-dimensional engine. However, such techniques are computationally intensive, and may require in depth development coding skills to achieve the three-dimensional and depth effects.

### SUMMARY OF THE INVENTION

The present invention is directed to computerized methods and systems, which create stereoscopic presentations of digital content from two dimensional components.

Embodiments of the present invention are directed to a method for creating a stereoscopic presentation of digital content. The method comprises: receiving an assigned depth value for each of one or more components in a layout editor, each of the one or more components having an associated initial spatial position in two dimensions; determining a corresponding offset value from the assigned depth value for each of the one or more components; for each of the one or more components, shifting the initial spatial position of the component by the corresponding offset value separately in a first direction and a second direction; and presenting the one or more components shifted in the respective first and second directions.

Optionally, the presenting includes: generating a first presentation that includes a first subset of the shifted components, and a second presentation that includes a second subset of the shifted components.

Optionally, the first and second subsets are non-overlapping subsets.

Optionally, the presenting includes: generating a presentation that includes each of the one or more components shifted in the first and second directions.

Optionally, the initial spatial position includes an initial vertical position and an initial horizontal position, and wherein the shifting, for each of the one or more components, includes shifting the initial horizontal position.

Optionally, the offset value is a function of the assigned depth value.

Optionally, the presenting includes: projecting the one or more components shifted in the respective first and second directions into the eyes of a user.

Optionally, the assigned depth value is received as input, from a user, as an alphabetical character string.

Optionally, the assigned depth value is received as input, from a user, as a numerical character string.

Optionally, the presenting includes generating a website.

Embodiments of the present invention are directed to a for creating a stereoscopic presentation of digital content. The method comprises: selectively assigning a depth value to one or more components in a layout editor, each of the one or more components having an associated initial spatial position in two dimensions; for each of the one or more components, shifting the initial spatial position of the component by an assigned offset value, the assigned offset value being a function of the assigned depth value; and presenting the one or more components shifted in the respective first and second directions.

Optionally, the presenting includes: generating a first presentation that includes a first subset of the shifted components, and a second presentation that includes a second subset of the shifted components.

Optionally, the first and second subsets are non-overlapping subsets.

Optionally, the presenting includes: generating a presentation that includes each of the one or more components shifted in the first and second directions.

Optionally, the presenting includes: projecting the one or more components shifted in the respective first and second directions into the eyes of a user.

Optionally, the presenting includes generating a website.

Embodiments of the present invention are directed to a system for creating a stereoscopic presentation of digital content. The system comprises: a user interface configured to: receive as input, an assigned depth value for each of one or more components selected for editing, each of the one or more components having an associated initial spatial position in two dimensions; a depth transformation module configured, for each selected component, to: determine an offset value from the assigned depth value, and shift the initial spatial position of the component by the offset value separately in a first direction and a second direction; and a rendering module configured to: present the one or more components shifted in the respective first and second directions.

Optionally, the system further comprises: a layout editor for editing components.

Optionally, the system further comprises: a content library for storing a plurality of components, the plurality of components being selectively editable, by a user, in the layout editor.

Optionally, the system further comprises: a viewing device for projecting the presented one or more components into the eyes of a user.

Optionally, the viewing device is embedded inside a user head mounted frame.

Optionally, the viewing device includes: a first display for projecting a first subset of the shifted components into a first eye of the user, and a second display for projecting a second subset of the shifted components into a second eye of the user.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram of the architecture of an exemplary system embodying the invention;

FIG. 2 is a diagram illustrating a system environment in which an embodiment of the invention is deployed;

FIG. 3A is a schematic represented of the initial position of components, as placed in a layout editor of the system according to an embodiment of the invention;

FIGS. 3B and 3C are schematic representations of right-shifts and left-shifts, respectively, applied to the initial positions of the components illustrated in FIG. 3A, according to an embodiment of the invention;

FIG. 4 is a front isometric view of a viewing device for viewing a stereoscopic presentation, according to an embodiment of the invention;

FIG. 5 is a diagram of the architecture of an exemplary computer system through which embodiments of the present invention can be accessed; and

FIG. 6 is a flow diagram illustrating a process to create a stereoscopic presentation, according to an embodiment of the invention.

### DESCRIPTION OF THE PREFERRED EMBODIMENTS

The present invention is directed to computerized methods and systems, which create stereoscopic presentations of digital content (e.g., websites) from two dimensional components. The components are placed in a layout editor for editing by a user of the system. The user assigns a depth value to each component, and the depth value is transformed into an offset value via a mapping function. The system then applies a right-shift and a left-shift to the position of each component, by the corresponding offset value, and publishes the shifted components as one or more presentations, by creating the presentation for each eye of the user, to display a perceived depth effect to a user when viewing the published presentation(s).

The principles and operation of the methods and systems according to present invention may be better understood with reference to the drawings accompanying the description.

The present invention is applicable to different types of presentations of digital content. Such presentations include, but are not limited to, websites, video games, digital media presentations, virtual reality (VR) systems.

Within the context of this document, the terms “publish”, “published”, “publishes”, and “publishing”, when attributed to a digital content, generally refers to the act or process of presenting the digital content to users, or the public at larger, in final form. For example, when the digital content is part of a website, the aforementioned “publishing” of the website refers to the act or process of making the website available for access, via the world wide web, via hosting by one or more web servers connected to a network.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

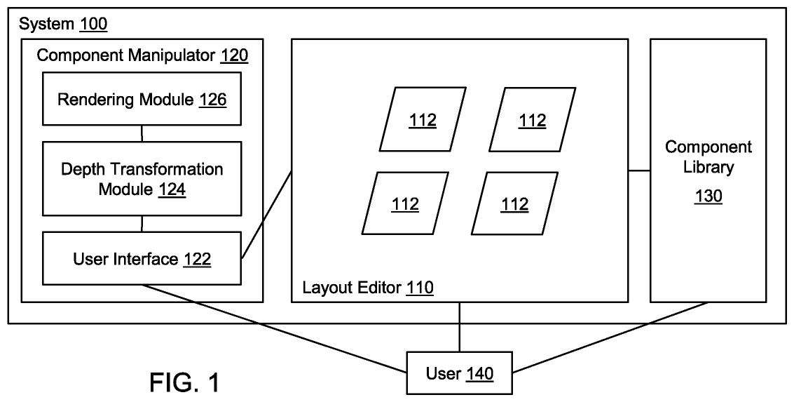

Referring now to the drawings, FIG. 1 shows a block diagram of a system, generally designated 100, for creating a stereoscopic presentation, according to an embodiment of the present disclosure. The system 100 includes a layout editor 110, a component manipulator 120, and a component library 130. In order to better explain the embodiments of the present disclosure, the system 100 will be described herein, in many instances, within the context of an exemplary embodiment in which the digital content to be displayed is web content, and the presentation is a stereoscopic website. The description of the system 100 within the context of the creation of a stereoscopic website should not limit the applications of the system 100 to other presentation formats, such as those listed in the non-exhaustive list of formats provided above, which include, for example, video games and digital media presentations.

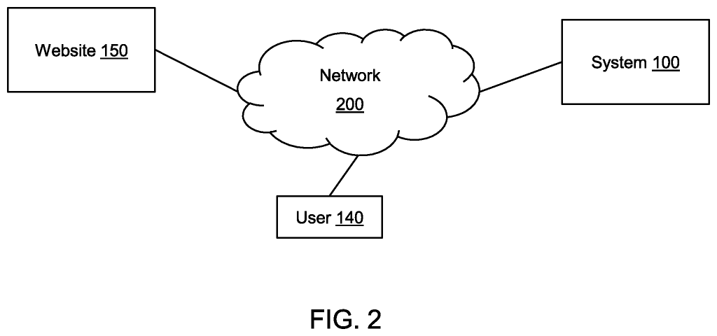

With continued reference to the drawings, FIG. 2 shows a diagram illustrating a system environment in which the system 100 can be deployed, according to certain embodiments of the present disclosure. In such embodiments, the system 100 is accessible by a user 140 via a website 150 through a network 200, which may be formed of one or more networks, including for example, the Internet, cellular networks, private networks (e.g., an Intranet), wide area, public, and local networks. In such embodiments, the layout editor 110, the component library 130, and components of the component manipulator 120 are displayed as part of the website 150, which is hosted by one or more web servers (not shown) connected to the network 200. As such, the user 140 accesses the system 100 through the website 150 via a computer or computer system, such as, for example, a laptop or desktop computer, and interacts with the components of the system 100 through peripheral input devices, e.g., a computer mouse and/or keyboard, of the computer or computer system.

Within the context of this document, the user 140 generally refers to a person or entity that uses the system 100 in order to create, design, or build a stereoscopic presentation (e.g., website). In certain sections of this document, the user 140 may also refer to a person or entity that views a stereoscopic presentation (e.g., website) that is rendered by the system 100. Accordingly, depending on the context, the user 140 may refer to either the creator or viewer of the stereoscopic presentation, and as such, the creator and viewer may be the same person or entity, or may be different people or entities.

The layout editor 110 provides functionality which allows the user 140 to edit and manipulate parameters of one or more components 112 for presentation. The layout editor 110 may be implemented as any conventional layout editor used to edit components. The components 112 may include a variety of different types, including, but not limited to, image or picture components, video components, text components, and shape components. Such components may include internal content, such as text paragraphs components, whose internal content includes displayed text, as well as font, formatting and layout information. The components 112 may be static, in which such a component does not move from a given position, or dynamic, in which the position of such a component may change, either periodically, intermittently, or continuously.

According to certain embodiments, the layout editor 110 receives components for editing from the component library 130, which retains a variety of components which can be placed in the layout editor 110 in response to input commands issued by the user 140. For example, the user 140 may provide input commands via an input device, such as a computer mouse or keyboard, to select components from the component library 130 for editing in the layout editor 110. A conventional technique for such selection of components is via “drag-and-drop” tools, in which the user 140 selects one or more components from the component library 130 via a computer mouse click, and drags the selected component to the layout editor 110 for editing. The user 140 may then edit one or more parameters of each component. The layout editor 110 may be a dedicated layout editor developed specifically for the system 100. Alternatively, the component manipulator 120 may be integrated with an existing web building platform having its own layout editor.

According to certain embodiments, the system 100 provides a “codeless” building platform whereby the user 140 is able to design and create presentations without requiring knowledge of development coding and scripting languages, such as JavaScript. In embodiments in which the digital content is published as part of a website (i.e., when the presentation is a website), the system 100 preferably supports the HTML5 web presentation format. However, in alternative embodiments, the system 100 may be configured to support other web presentation formats as well, such as, for example, web presentation formats for mobile sites.

For a given component, the editable parameters may include, for example, the size and shape of the component, and for text components, the font, format and layout of the text. The editable parameters also include, of particular significance, the spatial position, in two-dimensions, of the selected component. Each of the components 112 positioned in the layout editor 110 has an associated horizontal and vertical position. The horizontal and vertical positions in the layout editor translate to relative horizontal and vertical positions in the published presentation that displays the components 112. In a conventional layout editor, the horizontal and vertical positions of a selected component are adjustable, so as to allow user selective movement of the selected component in the layout editor 110.

In order to create a stereoscopic effect, the component manipulator 120 is deployed to allow the user 140 to select a desired depth value for one or more selected components in the layout editor 110. The component manipulator 120 shifts the initial position of a selected component by an assigned horizontal offset value to create two shifted versions of the selected component, that when viewed by the user 140 create a stereoscopic effect giving the illusion of depth for the selected component.

Within the context of this document, the term “initial position”, when applied to a component in the layout editor 110, refers to the spatial position in two-dimensions of a component prior to applying a positional shift along the horizontal dimension to create the stereoscopic effect, and is defined by an initial vertical position and an initial horizontal position.

The component manipulator 120 includes a user interface (UI) 122, a depth transformation module 124, and a rendering module 126. The user 140 selects one or more components 112 in the layout editor 110 for which a depth value is to be assigned. For a given selected component, the user 140 inputs a depth value via the UI 122, thereby assigning the depth value to the selected component 112. The depth value may be input by the user 140 as an alphabetical character string. For example, the user 140 may input the alphabetical character string ‘NEAR’, via the UI 122, to indicate that the selected component 112 is to have a relatively small stereoscopic depth, giving the selected component 112 the appearance of being near or close to the user 140, when the selected component 112 is published. Similarly, the user 140 may input the alphabetical character string ‘FAR’, via the UI 122, to indicate that the selected component 112 is to have a relatively large stereoscopic depth, giving the selected component 112 the appearance of being far or distant from the user 140, when the selected component 112 is published.

Alternatively, the depth value may be input by the user 140 as a numerical character string. For example, the user 140 may input the numerical character string ‘100’, via the UI 122, to indicate that the selected component 112 is to have a relatively small stereoscopic depth, similar to the ‘NEAR’ alphabetical character string example above. Similarly, the user 140 may input the numerical character string ‘400’, via the UI 122, to indicate that the selected component 112 is to have a relatively large stereoscopic depth, similar to the ‘FAR’ alphabetical character string example above. As should be apparent, the range of input values may be bounded and mapped to relative depth values.

The depth value input by the user 140 via the UI 122 is provided to the depth transformation module 124, which determines the required horizontal offset value to achieve the illusion of depth at the assigned depth value. The determination of the horizontal offset value is based on a function that maps assigned depth values to horizontal offset values, such that each assigned depth value maps to a corresponding assigned horizontal offset value. As such, the horizontal offset value is a function of the assigned depth value. The mapping function may be a linear function or a non-linear function, such as, for example, a polynomial function of degree n. Preferably, the function is a monotonic function. In general, the horizontal offset increases as the desired depth decreases, i.e., goes from far to near. This means that a relatively large horizontal offset is needed when creating a near depth effect, and a relatively small horizontal offset value is needed when creating a far depth effect. In certain preferred embodiments, the relatively small horizontal offset needed for creating a far depth effect is zero or approximately zero.

Within the context of this document, the initial position of a selected component is denoted by the coordinates (x, y), where x denotes the initial horizontal positional value of the selected component, and y denotes the initial vertical positional value of the selected component. Upon determining the horizontal offset value, denoted as Δx, the depth transformation module 124 shifts the initial horizontal position of the selected component by the horizontal offset value, separately in two directions, along the horizontal axis. As a result, the selected component is translationally moved in two directions, namely to the left and to the right, by the horizontal offset value. The left and right shifted components are viewed by different eyes of the user 140, which creates the stereoscopic effect. The system 100 is preferably configured to map the maximum perceived depth to a horizontal offset value of zero. As such, as the perceived depth is moved from far to near, the right-shifted component is viewed by the left eye of the user 140 and the left-shifted component is viewed by the right eye of the user 140.

Note that the position of a component in the layout editor 110 is specified by the horizontal and vertical positions of one or more pixels of the component. Typically, one such pixel, referred to as an anchor pixel, is used to represent the position of the component, such that the positions of all of the remaining pixels of the component are determined relative to the position of the anchor pixel. As such, the (x, y) coordinates specifying the position of a component typically refer to the x and y coordinate values of the anchor pixel of that component. When the x coordinate of the anchor pixel is shifted by the horizontal offset value, the x coordinates of all other pixels of the component are shifted by the same horizontal offset value, so as to preserve the aspect ratio of the component.

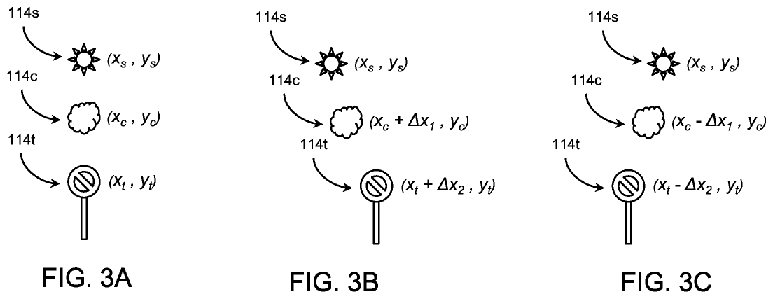

With continued reference to FIGS. 1 and 2, refer now to FIGS. 3A-3C, an example of the shifting of three different components according to different assigned depth values for each of the components 114s, 114c and 114t. For illustration purposes, the first component is represented schematically as a sun 114s, the second component is represented schematically as a cloud 114c, and the third component is represented schematically as a traffic sign 114t.

FIG. 3A illustrates the initial positions of the three components as placed in the layout editor 110. The initial position of the sun 114a is denoted by the coordinates (xₛ, yₛ). The initial position of the cloud 114b is denoted by the coordinates (x_{c}, y_{c}). The initial position of the traffic sign 114a is denoted by the coordinates (xₜ, yₜ). As shown in FIG. 3A, the three components are aligned such that horizontal positional values of the three components are the same. In other words, the three values xₛ, x_{c}, and xₜ are equal.

FIGS. 3B and 3C illustrate the shifts applied to the initial positions of the three components, to the right (i.e., viewed by the left eye of the user 140) and to the left (i.e., viewed by the right eye of the user 140), respectively, in order to generate a stereoscopic depth effect in which the sun 114s has the appearance of being far or distant from the user 140, the traffic sign 114t has the appearance of being near or close to the user 140, and the cloud 114c has the appearance of being at a depth between the depth of the sun 114s and the traffic sign 114t. For clarity, the depth of the cloud 114c, as perceived by the user 140, is referred to as zero-depth (or center-depth).

Since the sun 114s has a depth value which is perceived as the maximum depth, when compared to the cloud 114c and the traffic sign 114t, the depth value of the sun 114s maps to a horizontal offset value of zero. As such, the sun 114s is not shifted, and remains in the same initial horizontal and vertical positions in FIGS. 3B and 3C as those illustrated in FIG. 3A.

The traffic sign 114t has a depth value which is perceived as the minimal depth, when compared to the sun 114s and the cloud 114c. The depth value of the traffic sign 114t maps to a horizontal offset value of Δx₂, and as such, the initial horizontal position of the traffic sign 114t is shifted to the right and to the left by Δx₂. The resultant right-shifted horizontal position of the traffic sign 114t is xₜ+Δx₂, which is viewed by the left eye of the user 140 (FIG. 3B). The resultant left-shifted horizontal position of the traffic sign 114t is xₜ−Δx₂, which is viewed by the right eye of the user 140 (FIG. 3C).

The cloud 114c has a depth value which corresponds to a perceived depth between that of the sun 114s and the traffic sign 114t. As mentioned above, this depth is referred to as zero-depth. The depth value of the cloud 114c maps to a horizontal offset value of Δx₁, and as such, the initial horizontal position of the cloud 114c is shifted to the right and to the left by Δx₁. The resultant right-shifted horizontal position of the cloud 114c is x_{c}+Δx₁, which is viewed by the left eye of the user 140 (FIG. 3B). The resultant left-shifted horizontal position of the cloud 114c is x_{c}−Δx₁, which is viewed by the right eye of the user 140 (FIG. 3C).

The rendering module 126 receives, as input from the depth transformation module 124, the positions of the left and right shifted components from the depth transformation module 124, and publishes the left and right shifted components as one or more presentations. The rendering module 126 also receives, as input, from the layout editor 110, the initial positions of the components in the layout editor 110. The rendering module 126 publishes the content of the layout editor 110 by generating shifted versions of the components, in accordance with the positions of the left and right shifted components received from the depth transformation module 124, to present the shifted components to different respective eyes of the user 140 (i.e., the right-shifted components to the left eye, and the left-shifted components to the right-eye). The number of presentations published is a function of the viewing device through which the user 140 views the published digital content. In certain embodiments, two distinct presentations are published, one version that includes the subset of shifted components to be viewed by the left eye of the user 140, and another website that includes the subset of shifted components to be viewed by the right eye of the user 140. In embodiments in which the digital content is published as part of a website, the publication of two distinct presentations yields two distinct versions of the website.

As a result of the execution of the functions performed by the depth transformation module 124 and the rendering module 126, each eye of the user 140 is presented with a different spatial version of digital content, which are generated by the rendering module 126 based on the shifted components produced by the depth transformation module 124.

Although the embodiments described thus far have pertained to a component manipulator, of the system 100, that includes the UI 122 as being part of the component manipulator 120, as illustrated in FIG. 1, other embodiments are possible, in which the UI 122 is deployed separate from the component manipulator 120. For example, the UI 122, may be part of an existing building platform having its own layout editor and component library, and the depth transformation module 124 and the rendering module 126 may be configured to operate with the system components of such an existing building platform.

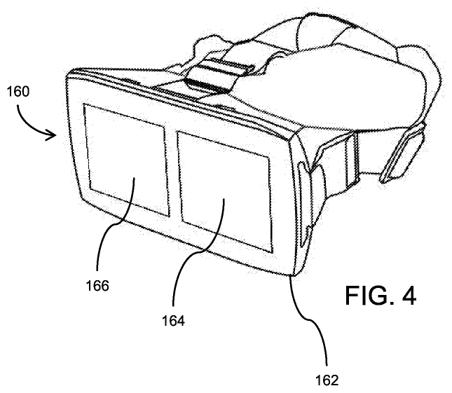

With continued reference to FIGS. 1-3C, refer now to FIG. 4, a specialized viewing device 160 used to view published digital content according to certain embodiments of the present disclosure. In a non-limiting implementation, the viewing device 160 is mounted in a head-mounted frame 162 which is worn on the face of the user 140 similar to a pair of eyeglasses or virtual reality goggles. The viewing device 160 includes two electronic displays, namely a first display 164 and a second display 166. The first display 164 projects the shifted components, to be viewed by the left eye of the user 140 (FIG. 3B), into the left eye of the user 140. The second display 164 projects the shifted components, to be viewed by the right eye of the user 140 (FIG. 3C), into the right eye of the user 140. The stereoscopic depth effect is achieved when the brain of the user 140 combines the images projected separately into the left and right eye. As such, two distinct presentations (e.g., websites) are published by the rendering module 126, one presentation (e.g., website) to be viewed by the left eye of the user 140, and another presentation (e.g., website) to be viewed by the right eye of the user 140. Note that in such an embodiment, the first display 164 only projects the shifted components to be viewed by the left eye of the user 140 and does not project any of the shifted components to be viewed by the right eye of the user 140. Similarly, the second display 164 only projects the shifted components to be viewed by the right eye of the user 140 and does not project any of the shifted components to be viewed by the left eye of the user 140. As such, two subsets of shifted components are non-overlapping subsets.

In other embodiments, the rendering module 126 may publish a single presentation (e.g., website), in which the right-shifted components, to be viewed by the left eye of the user 140 (FIG. 3B), and the left-shifted components, to be viewed by the right eye of the user 140 (FIG. 3C), are overlaid in a single presentation. In such embodiments, a specialized viewing device having an autostereoscopic display is deployed to allow each eye of the user 140 to view the intended shifted components. As is known in the art, autostereoscopic displays include two broad classes of displays, namely displays which include user head-tracking techniques in order to ensure that the each of the eyes of the user 140 view a different image on the display, and displays that display multiple views such that the display does not require knowledge of the direction at which the eyes of the user 140 are pointed. Examples of autostereoscopic displays include parallax barrier, lenticular, volumetric, electro-holographic, and light field displays. Also note that certain types of stereoscopic displays include capability for recreating the perception of movement parallax, such as displays used by the Nintendo 3DS™ video game system, and VR headsets for the PlayStation® from Sony Corporation.

Although not shown in the drawings, the viewing device used by the user 140 to view the published presentation(s) (e.g., website(s)) includes communications hardware and/or software to enable receipt of digital content on the viewing device, and further includes electronics and other hardware for displaying the received web content, as should be apparent to one of ordinary skill in the art. In embodiments in which the digital content is published as part of a website, such communication hardware and/or software includes network hardware and/or software which enables the receipt of web content over a network (e.g., the network 200).

As illustrated in the examples described above, in particular with reference to FIGS. 3A-3B, the assigned depth values for each component in the layout editor 110 may be different, or individualized for certain components, such that different components have different stereoscopic depths when published and viewed by the user 140 through the appropriate viewing device. As a result, a parallax effect induced when the user 140 views the components of different depth, through the appropriate viewing device.

According to certain embodiments, the depth value assigned to a given component may be dynamic, such that the depth value changes with respect to a variable. The variable may be an independent variable, such as, for example, time, or may be associated with the component, such as, for example, the position of the component. As such, the component may have a perceived depth that varies with time, position, or a combination thereof. For example, a component may have a near perceived depth when viewing the published presentation(s) (e.g., website(s)) during one period of the day, and may have a far perceived depth when viewing the presentation(s) (e.g., website(s)) during other periods of the day. Similarly, a dynamic component (i.e., a component that moves throughout the published presentation) may have a near perceived depth when positioned in one region of the presentation, and may have a far perceived depth when positioned in another region of the presentation.

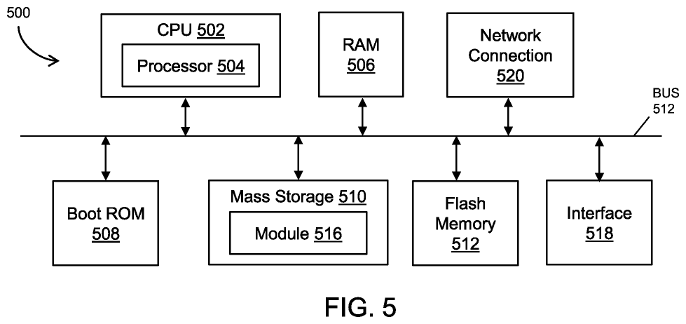

Referring now to FIG. 5, a diagram of an example architecture of a computer system 500 through which embodiments of the system 100 of the present disclosure can be accessed by the user 140. The computer system 500 includes a central processing unit (CPU) 502 that is formed of one or more processors 504. The processors, which can include microprocessors are, for example, conventional processors, such as those used in servers, computers, and other computerized devices. For example, the processors may include x86 Processors from AMD and Xeon® and Pentium® processors from Intel, as well as any combinations thereof.

The computer system 500 further includes four exemplary memory devices: a random-access memory (RAM) 506, a boot read-only memory (ROM) 508, a mass storage device (i.e., a hard disk) 510, and a flash memory 512. As is known in the art, processing and memory can include any computer readable medium storing software and/or firmware and/or any hardware element(s) including but not limited to field programmable logic array (FPLA) element(s), hard-wired logic element(s), field programmable gate array (FPGA) element(s), and application-specific integrated circuit (ASIC) element(s). Any instruction set architecture may be used in the CPU 502 including but not limited to reduced instruction set computer (RISC) architecture and/or complex instruction set computer (CISC) architecture. A module (i.e., a processing module) 516 is shown on the mass storage device 510, but as will be obvious to one skilled in the art, could be located on any of the memory devices.

The mass storage device 510 is a non-limiting example of a non-transitory computer-readable storage medium bearing computer-readable code for implementing the stereoscopic presentation creation methodology described herein. The non-transitory computer readable (storage) medium may be a computer readable signal medium or a computer readable storage medium. Other examples of a computer readable storage medium include, but are not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a RAM, a ROM, an erasable programmable ROM (EPROM or Flash memory), an optical fiber, a portable compact disc ROM (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

The computer system 500 may have an operating system (OS) stored on one or more of the memory devices. The OS may include any of the conventional computer operating systems, such as those available from Microsoft of Redmond Wash., commercially available as Windows® OS, such as, for example, Windows® XP, Windows® 7, Windows® 8 and Windows® 10, MAC OS from Apple of Cupertino, Calif., or Linux.

The ROM 508 may include boot code for the computer system 500, and the CPU 502 may be configured for executing the boot code to load the OS to the RAM 506, executing the operating system to copy computer-readable code to the RAM 506 and execute the code.

A peripheral device interface 518 provides one or more interfaces for peripheral devices, such as for example, display devices and user input devices, which may include, but are not limited to, a computer mouse and a keyboard. A network connection 520 provides communications to and from the computer system 500 over a network, such as for example, the network 200. Typically, a single network connection provides one or more links, including virtual connections, to other devices on local and/or remote networks. Alternatively, the computer system 500 can include more than one network connection (not shown), each network connection providing one or more links to other devices and/or networks.

All of the components of the computer system 500 are connected to each other (electronically and/or data), either directly or indirectly, through one or more connections, exemplified in FIG. 5 as a communication bus 514.

The computer system 500 can be implemented as a computer, which includes machines, computers and computing or computer systems (for example, physically separate locations or devices), servers, computer and computerized devices, processors, processing systems, computing cores (for example, shared devices), virtual machines, and similar systems, workstations, modules and combinations of the aforementioned. The aforementioned computer may be in various types, such as a personal computer (e.g. laptop, desktop, tablet computer), or any type of computing device, including mobile devices that can be readily transported from one location to another location (e.g. smartphone, personal digital assistant (PDA), mobile telephone or cellular telephone.

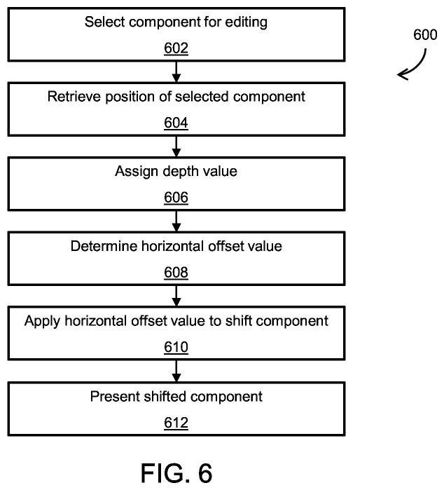

Attention is now directed to FIG. 6 which shows a flow diagram detailing a computer-implemented process 600 in accordance with embodiments of the disclosed subject matter. The computer-implemented process includes an algorithm for creating a stereoscopic presentation from two-dimensional components. Reference is also made to elements shown in FIGS. 1-5. The processes and sub-processes of FIG. 6 are computerized processes performed by the system 100 when executed, for example, on the computer system 500. Some or all of the aforementioned processes and sub-processes are, for example, performed automatically, but can be, for example, performed manually, and are performed, for example, in real-time.

The process 600 begins at block 602, where the user 140 of the computer system 500, through which the system 100 is accessed, selects a component for editing. The selection of the component for editing may include selecting the component, in the layout editor 110, via a right or left computer mouse click. The selection performed in block 602 may also include placing the component, selected from the component library 130, in the layout editor 110.

The process 600 then moves to block 604, where upon selecting the component in block 602, the system 100 retrieves the initial position of the selected component. The position of components may be stored as parameters and/or attributes and/or characteristics in a memory or server linked to the system 100, or on one of the memory devices of the computer system 500. Subsequently or in parallel to block 604, the system moves to block 606, where the user 140 of the system 100 assigns a depth value to the selected component via the UI 122. In a non-limiting implementation, the UI 122 is implemented as a dialogue box, operative to receive user input, and which may appear upon selection of the component for editing (i.e., execution of block 602). The assignment of the depth value may be implemented using one or more user input device. For example, the user may input the depth value using the keyboard. Alternatively, the UI 122 may include a predefined list of depth options, selectable from a menu, such as, for example, a drop-down menu, via a mouse or keyboard.

The process 600 then moves to block 608, where the depth transformation module 124 determines the required horizontal offset value to achieve the stereoscopic depth at the assigned depth value. As discussed above, the determination of the horizontal offset value is based on a function that maps assigned depth values to horizontal offset values. The process 600 then moves to block 610, where horizontal offset value determined in block 608 is applied to the initial position of the selected component. The result of the application of the horizontal offset value is a positional shift, in two directions, of the selected component, resulting in a left-shifted version of the component and a separate right-shifted version of the component.

The process 600 then moves to block 612, where the shifted versions of the selected component are published, by the rendering module 126, to generate one or more presentations (e.g., websites) for viewing, on a viewing device (e.g., the viewing device 160), thereby presenting the shifted versions of the components to the user 140 or a viewer of the presentation. As discussed above, the number of presentations published is dependent on the type of viewing device used by the viewer or the user 140. As discussed above, the right-shifted component is presented to the left eye of the user 140 and left-shifted component is presented to the right eye of the viewer.

As should be apparent, the process 600 may be executed for editing sessions in which depth values are assigned to multiple components before the overall content in the layout editor 110 is published as a presentation or presentations by the rendering module 126. As such, the blocks 602-610 of the process 600 may be repeated for different components during a single editing session prior to the execution of block 612.

Although embodiments of the system 100 as described thus far have pertained to individually assigning depth values to components, other embodiments are possible, in which depth values of components are interdependent, for example, in which the depth value assigned to one component affects the depth value assigned to another component. In such embodiments, for example, the user 140 may desire that one component has a relatively shallow depth relative to the depth of a second component. As such, the user 140 may assign a depth value to the shallow depth component, via the system 100, and the component manipulator 120 may use the assigned depth value of the shallow depth component as input to the depth transformation module 124 when determining the offset value for the second component.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system, such as the OS of the computer system 500.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A method for creating a stereoscopic presentation of digital content, comprising:
receiving an assigned depth value for each of one or more components in a layout editor, each of the one or more components having an associated initial spatial position in two dimensions;
determining a corresponding offset value from the assigned depth value for each of the one or more components;
for each of the one or more components, shifting the initial spatial position of the component by the corresponding offset value separately in a first direction and a second direction; and
presenting the one or more components shifted in the respective first and second directions.

2. The method of claim 1, wherein the presenting includes: generating a first presentation that includes a first subset of the shifted components, and a second presentation that includes a second subset of the shifted components.

3. The method of claim 2, wherein the first and second subsets are non-overlapping subsets.

4. The method of claim 1, wherein the presenting includes: generating a presentation that includes each of the one or more components shifted in the first and second directions.

5. The method of claim 1, wherein the initial spatial position includes an initial vertical position and an initial horizontal position, and wherein the shifting, for each of the one or more components, includes shifting the initial horizontal position.

6. The method of claim 1, wherein the offset value is a function of the assigned depth value.

7. The method of claim 1, wherein the presenting includes: projecting the one or more components shifted in the respective first and second directions into the eyes of a user.

8. The method of claim 1, wherein the assigned depth value is received as input, from a user, as an alphabetical character string.

9. The method of claim 1, wherein the assigned depth value is received as input, from a user, as a numerical character string.

10. The method of claim 1, wherein the presenting includes generating a website.

11. A method for creating a stereoscopic presentation of digital content, comprising:
selectively assigning a depth value to one or more components in a layout editor, each of the one or more components having an associated initial spatial position in two dimensions;
for each of the one or more components, shifting the initial spatial position of the component by an assigned offset value, the assigned offset value being a function of the assigned depth value; and
presenting the one or more components shifted in the respective first and second directions.

12. The method of claim 11, wherein the presenting includes: generating a first presentation that includes a first subset of the shifted components, and a second presentation that includes a second subset of the shifted components.

13. The method of claim 12, wherein the first and second subsets are non-overlapping subsets.

14. The method of claim 11, wherein the presenting includes: generating a presentation that includes each of the one or more components shifted in the first and second directions.

15. The method of claim 11, wherein the presenting includes: projecting the one or more components shifted in the respective first and second directions into the eyes of a user.

16. The method of claim 11, wherein the presenting includes generating a website.

17. A system for creating a stereoscopic presentation of digital content, comprising:
a user interface configured to:
receive as input, an assigned depth value for each of one or more components selected for editing, each of the one or more components having an associated initial spatial position in two dimensions;
a depth transformation module configured, for each selected component, to:
determine an offset value from the assigned depth value, and
shift the initial spatial position of the component by the offset value separately in a first direction and a second direction; and
a rendering module configured to:
present the one or more components shifted in the respective first and second directions.

18. The system of claim 17, further comprising:
a layout editor for editing components.

19. The system of claim 18, further comprising:
a content library for storing a plurality of components, the plurality of components being selectively editable, by a user, in the layout editor.

20. The system of claim 17, further comprising:
a viewing device for projecting the presented one or more components into the eyes of a user.

21. The system of claim 20, wherein the viewing device is embedded inside a user head mounted frame.

22. The system of claim 20, wherein the viewing device includes: a first display for projecting a first subset of the shifted components into a first eye of the user, and a second display for projecting a second subset of the shifted components into a second eye of the user.
